(19) United States
(12) Patent Application Publication
(10) Pub. No.: US 2009/0199481 A1
(43) Pub. Date: Aug. 13, 2009

(54) Door mounting system for interior doors

(75) Inventor: Richard G. Kluge, Lake Geneva, WI (US)

Correspondence Address: WOOD, PHILLIPS, KATZ, CLARK & MORTIMER, 500 W. MADISON STREET, SUITE 3800, CHICAGO, IL, 60661, US

(73) Assignee: John Sterling Corporation

(21) Appl. No.: 12/069,718

(22) Filed: Feb. 12, 2008

(51) Int. Cl. E05D 15/58

(52) U.S. Cl. 49/260

(57) ABSTRACT

A door-mounting system facilitates mounting of one or more closed doors in a fashion which facilitates substantially full-access to the closet. The mounting system includes upper and lower mounting plates which each define first and second guide tracks, with upper and lower pairs of guide members, operatively connecting the associated door to the guide tracks, mounting the door for generally arcuate movement with respect to the door opening. The system includes an arrangement by which the guide members can be selectively positioned to selectively vary the degree to which the door projects through and into the associated closet of the like, thus facilitating use of the present system in those applications which may include a relatively shallow closet or like enclosure. The present door mounting system includes an arrangement of one or more trim members which can be optionally employed to cover any gap between a side edge of the door and an associated side frame by facilitating fitment of one or more doors to door openings of varying widths.

### TECHNICAL FIELD

The present invention relates generally to a door-mounting system for interior doors, such as for closet or wardrobe doors and the like, and more particularly to an arrangement by which one or more doors can be mounted for generally arcuate movement with respect to a door opening, by which the extent to which the door projects into the opening, in an opened position thereof, can be selectively varied, thus permitting selective mounting of the door so that it does not interfere with articles within the closet, or furniture or the like outwardly of the door opening. Another aspect of the present invention facilitates fitment of doors to door openings which may vary in width, with additional features of the present system facilitating convenient and efficient door mounting.

### BACKGROUND OF THE INVENTION

Closets, wardrobes, and other like enclosures within a home or apartment are typically provided with one or more doors for closing the interior space. Typical hinge-mounted doors are in widespread use in view of their simple and secure mounting, with such hinged doors desirably providing full access to the interior of the closet, without the door interfering with any articles within the closet.

On balance, such typical hinged doors require sufficient space exterior of the closet to permit the doors to be fully opened, and thus can undesirably detract from convenient placement of furniture or the like at the exterior of the closet. In view of this, sliding, so-called by-pass doors are frequently used for closets, since such doors do not interfere with either articles within the closet, or objects positioned outward of the close. However, by their nature, by-pass doors, which must be positioned in overlapping relationship when one of a plurality of such doors is opened, can never be simultaneously positioned for permitting full access to the closed; at least a portion of the closet remains closed by the overlapped by-pass doors.

In an effort to address this shortcoming, bi-fold doors have replaced by-pass doors in popularity, principally because they permit a greater portion of the closet or wardrobe opening to be available when in an open position. However, bi-folding door installations typically require twice as many door panels as a comparable by-pass door arrangement, increasing expense. Additionally, the suspension and mounting hardware for such bi-fold doors can be susceptible to greater wear and misadjustment, detracting from convenient installation and use.

Addressing the shortcomings of the above types of closet door installations, a so-called full access door system has been developed by which one or more closet doors are mounted for generally arcuate movement with respect to a door opening. Such an arrangement is illustrated in U.S. Pat. No. 4,306,377, hereby incorporated by reference, with the mounting arrangement including upper and lower pairs of guide tracks in which door-mounted guide members respectively move. By this arrangement, each closet door is movable in a generally arcuate path, whereby a side edge of the door moves inwardly into the closet space as the door is opened. This arrangement desirably permits full access to the contents of the closet when the one or more doors are opened, while at the same time requiring less space exterior of the closet, when the door moves outwardly, in comparison to typical hingedly-mounted door arrangements.

While the mounting arrangement of the above-referenced patent provides a number of distinct advantages over other closed door-mounting arrangements, it will be appreciated that in its open position, the closet door extends partially into the closet, as well as extending outwardly into the associated room. However, because the depth of closets can vary, it may not always be possible to conveniently accommodate a portion of the door which moves into the closet space when it is opened. Additionally, the width of door openings can vary from one closet to another.

The present invention provides an improved arrangement of a full-access door system, which accommodates installation in closets of varying depths and varying widths, with additional features of the system facilitating convenient and efficient installation.

### SUMMARY OF THE INVENTION

A door-mounting system embodying the principles of the present invention is configured for mounting a door in a door opening, such as for a closet, wardrobe, or like interior application. The door-mounting system provides a full-access arrangement for the door-mounting, by which the interior of the closet can be readily substantially fully opened. Notably, the mounting system is configured to permit the door to be selectively mounted so that the extent to which the door projects into the opening, in its open position, can be selectively varied. Thus, the door can be conveniently mounted so as to prevent undesired interference with the interior of the closed, while still requiring less exterior space, when fully opened, than typical hingedly-mounted door arrangements. Additionally, the present door-mounting system includes features which permit one or more doors to be readily fitted in door openings of varying widths, with a desirably customized and finished appearance.

In accordance with the illustrated embodiment, the present door-mounting system includes upper and lower mounting plates configured for respective mounting on upper and lower horizontal surfaces at the top and bottom of the door opening. Each of the mounting plates includes a horizontal plate portion, and defines first and second guide tracks, which respectively define track axes which intersect with each other. As will be recognized by those familiar with the art, the arrangement of the guide tracks is such that movement of an associated door between its closed and open positions moves the door in a generally arcuate path of movement with respect to the door opening.

The present system further includes upper and lower door brackets configured for respective mounting generally at the upper and lower edges of the door, generally adjacent a side edge of the door. The system further includes upper and lower pairs of guide members, with each guide member of each pair being operatively movably engaged with a respective one of the first and second guide tracks of the upper and lower mounting plates. Each guide member is further engaged with the respective one of the upper and lower door brackets, so that movement of the guide members in the guide tracks permits the door to be moved, in a generally arcuate motion, inwardly and outwardly with respect to the door opening, between closed and opened positions.

Notably, each of the upper and lower door brackets define a plurality of guide member openings for receiving the respective second guide member, in selectively spaced relationship from the side edge of the door. By this arrangement, selected disposition of the second guide members in one of the plurality of guide member openings permits the door to be mounted to select the extent to which the door projects into the opening in the opened position thereof. Thus, for those installations which can accommodate the door projecting into the closed to a greater extent, the present system permits mounting of the door in such a fashion, thereby minimizing the extent to which the door extends into the adjacent room exteriorly of the closet. Conversely, the system permits the door to be mounted in a fashion to minimize the extent to which it projects into the closet, in its opened position, in those applications in which mounting in this fashion is desired.

An additional feature of the present door-mounting system facilitates installation of one or more doors to different door openings which may vary in width. To this end, the present system includes at least one trim member positionable at the side edge of the door, with the trim member having an outwardly facing surface for covering a gap between the side edge of the door and the side frame of the door opening. In the preferred form, first and second trim members are provided which are respectively optionally positionable on the side edge of the door and the side frame of the door opening, with outwardly facing surfaces of the trim member being positionable in overlapping relationship to cover any gap between the side edge of the door and the side jamb of the door opening.

In order to further facilitate convenient mounting of a door with the present system, the upper door bracket defines a plurality of slots for receiving mechanical fasteners for securing the door to the upper door bracket. Each of these slots preferably defines an irregular surface at a lower edge thereof to facilitate installation of mechanical fasteners and fitment of the door in the opening, by acting to prevent undesired movement or shifting of the door, relative to the bracket, as the mechanical fasteners are inserted and tightened into the door. Notably, the present system is preferably provided with a foot-operated jack member which is removably positionable beneath the door during mounting in the door opening, thereby facilitating convenient hanging of the door from the upper mounting plate as the lower pair of guide members are respectively positioned in the lower guide tracks.

For some applications, one or both of the upper and lower horizontal mounting surfaces at the door opening may not be sufficiently robust as to permit mounting of the respective upper and lower mounting plate on that surface. To thus further facilitate convenient installation, each of the upper and lower mounting plates includes a vertically oriented mounting flange, extending from the respective horizontal plate portion, to permit either one of the upper and lower mounting plates to be secured to a vertical surface defining the door opening.

Convenient installation, and periodic removal, of the door is facilitated by an arrangement by which the lower pair of guide members are spring-biased with respect to the lower door bracket. In particular, a pair of biasing springs are respectively mounted in captive relationship on each of the first and second guide members of the lower pair, with the biasing springs positioned between the lower door bracket and the lower ends of the guide members. By this arrangement, each of the first and second guide members of the lower pair is upwardly movable, in opposition to the respective one of the biasing springs, to permit the first and second guide members to be disengaged from the first and second guide tracks of the lower mounting bracket. This permits the door to be easily manipulated, and inserted into, or removed from the door opening, as may be required.

In the preferred embodiment, a pair of clip elements are provided which are respectively, removably positionable on the lower guide members between an upper end portion of each lower guide member, and the lower door bracket. The clip members desirably act to maintain the lower guide members in a retracted position, whereby the lower guide members are maintained in a disengaged relationship with the guide tracks of the lower mounting plate.

Other features and advantages of the present invention will become readily apparent from the following detailed description, the accompanying drawings, and the appended claims.

### BRIEF DESCRIPTION OF THE DRAWINGS

FIG. 1 is a diagrammatic view illustrating the door-mounting system of the present invention, showing the interior of a door mounted in an associated door opening;

FIG. 1a is a fragmentary, relatively enlarged view of the indicated portion of FIG. 1;

FIG. 2 is a diagrammatic view, similar to FIG. 1, illustrating the present door-mounting system, and associated door, from the exterior thereof;

FIG. 3 is a further diagrammatic view illustrating the present door-mounting system, wherein the system has been selectively adjusted to limit the extent to which the associated door projects into the door opening in the opened position thereof;

FIG. 4 is a diagrammatic, rear elevational view illustrating the present door-mounting system;

FIG. 5 is a diagrammatic cross-sectional view illustrating the present door-mounting system in a configuration which increases the degree to which the door projects into the associated closet in an opened position thereof;

FIG. 6 is a diagrammatic cross-sectional view, similar to FIG. 5, illustrating adjustment of the present door-mounting system for minimizing the degree to which the door projects into the associated closet in the opened position thereof;

FIGS. 7a and 7b are diagrammatic views illustrating the optional use of first and second trim members for facilitating mounting of one or more doors into door openings of varying widths;

FIG. 8 is a diagrammatic view illustrating installation of a door in a lower mounting plate of the present system; and

FIG. 9 is a diagrammatic view illustrating use of a foot-operated jack member for facilitating installation of one or more doors with the present mounting system.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

With reference to the drawings, therein is diagrammatically illustrated a door-opening system embodying the principles of the present invention. As will be further described, the present system permits mounting of a door D in an associated opening defined by an upper frame or jamb UF, a lower frame or jamb LF, and a side frame SF extending vertically between the upper and lower frame elements. The present mounting system permits the door D to be mounted for generally arcuate movement within the door frame between closed and opened positions, wherein the in opened position of the door, a portion of the door projects into the interior space at which the door is mounted, such as a closet, wardrobe, or the like. In accordance with the present invention, the present mounting system permits configuring the system in one of a plurality of configurations, by which the degree to which the door projects into the interior space, in its opened position, can be selectively varied during installation of the system. Additionally, the present mounting system includes features which can be optionally employed to facilitate mounting of one or more doors in door openings of varying widths.

Certain features of the present invention are generally in accordance with U.S. Pat. No. 4,306,377, hereby incorporated by reference. In accordance with this patent, the present mounting system generally suspends the door for movement from the top of the door opening, while simultaneously supporting and guiding the door at the lower end of the opening. Upper and lower guide tracks with which the door is operatively connected, guide the arcuate movement of the door between its closed and opened positions, while providing secure and stable mounting of the door.

To this end, the present door-mounting system includes upper and lower mounting plates 12, 14, each of which include respective horizontal plate portions 16 and 18. Each of the mounting plates further defines first and second guide tracks mounted on the respective horizontal plate portion. Thus, upper mounting plate 12 defines first and second guide tracks 20 and 22, while the lower mounting plate 14 defines first and second guide tracks 24 and 26.

As will be observed, the guide tracks of the mounting plates are configured such that they respectively define track axes which intersect with each other, with each of the first guide tracks extending generally inwardly toward the interior of the space at which the door is positioned, and with each of the second guide tracks extending in generally parallel relationship to the door opening, that is, in parallel relationship to the upper and lower frame members of the opening. As will be appreciated, the upper and lower mounting plates can be of substantially similar construction, with the upper and lower mounting plates being mirror images of each other.

In a typical application, it is contemplated that the upper and lower mounting plates 12, 14 be configured for respective mounting on upper and lower horizontal surfaces at the top and bottom of the door opening, such as onto upper frame UF and lower frame LF. However, experience has shown that for some applications, mounting in this fashion is not convenient or possible, for example, in those applications where the door opening is positioned on a concrete slab, or the door opening is constructed without a wood surface jamb for secure mounting. In some locales, many closet openings extend to the ceiling, with no jamb or stud above the opening. To facilitate mounting in these applications, each of the upper and lower mounting plates 12, 14 include a vertically oriented mounting flange, extending from the respective plate portion, to permit either one of the upper and lower mounting plates to be secured to a vertical surface defining the door opening. Accordingly, upper mounting plate 12 includes a vertically oriented mounting flange 17 extending integrally from horizontal plate portion 16, with lower mounting plate 14 similarly including a vertically orienting mounting flange 19 extending integrally from horizontal plate portion 18.

The present system further includes upper and lower door brackets 28 and 30 configured for respective mounting generally at the upper and lower edges of the door, generally adjacent a side edge of the door. In accordance with the preferred embodiment, the upper door bracket 28 includes a vertical leg portion 32, and a horizontal leg portion 34. In contrast, lower door bracket 30 has a generally U-shaped cross section, including a web portion 36 secured to the door D, and a pair of leg portions 38 extending integrally from the web portion 36. As will be appreciated, the upper and lower door brackets 28, 30 are secured to the inwardly facing surface of the door D by suitable mechanical fasteners (not shown) typically wood screws or the like. In this regard, experience has shown that during securement of these types of brackets to a door during mounting, the rotational tightening of the mounting screws in horizontal adjustment slots defined by the mounting bracket can cause the bracket to “walk” as the screw head rotates, and presses against the bracket surface. At the upper one of the brackets, at which the weight of the door is substantially supported, the weight of the door can press the screw to the bottom of the adjustment slot, and the screw head can have greater contact and friction with the metal below the slot than the metal above the slot. This tendency to “walk” can detract from convenient adjust of the door position in the mounting.

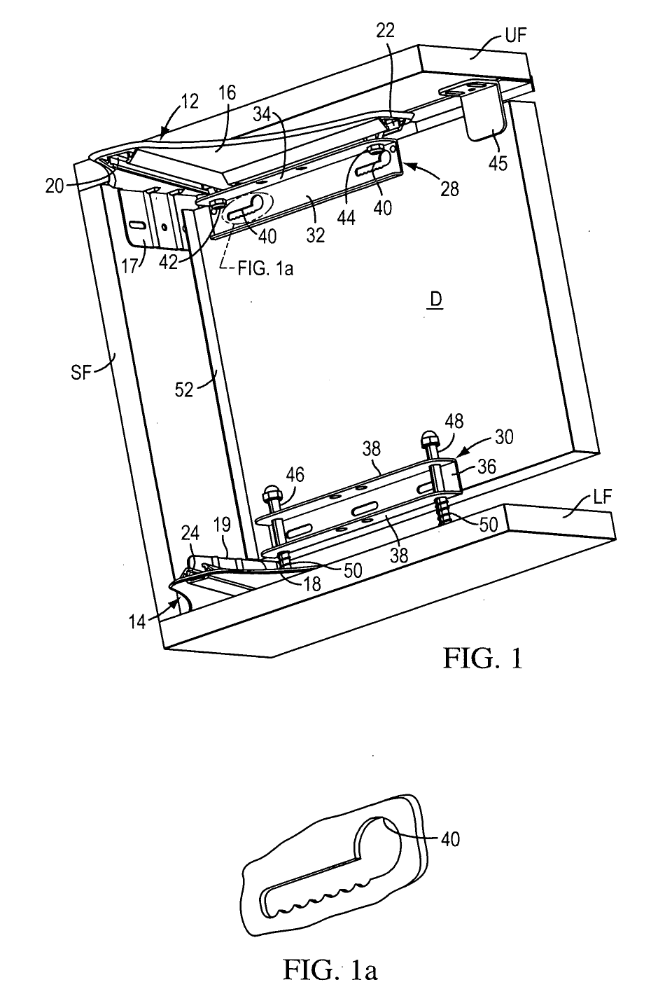

To address this shortcoming of previous designs, the vertical leg portion 32 of upper door bracket 28 defines a plurality of slots 40 for receiving mechanical fasteners for securing the door to the upper door bracket, with each of the slots defining an irregular surface at a lower edge thereof to facilitate installation of mechanical fasteners, and fitment of the door in the opening (see FIG. 1a). The provision of this irregular surface, in the form of a series of serrations in the lower edge of the mounting slot, has been found to desirably overcome this tendency for the bracket to “walk” during fastener installation, thus facilitating convenient adjustment of the door in the associated opening.

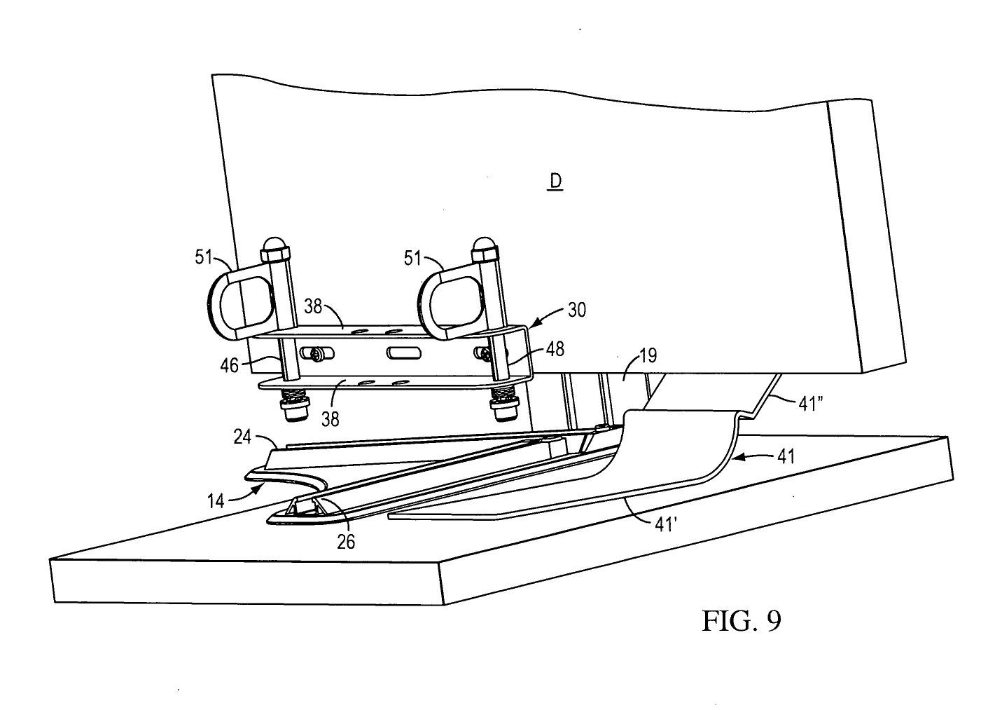

In a preferred embodiment of the present door-mounting system, installation of mechanical fasteners in the slots 40 and support and positioning of the door, is facilitated by the provision of a foot-operated jack member 41 (see FIG. 9) which can be removably positioned beneath the door during mounting in the door opening. The jack member 41 includes a pedal portion 41′, and a support portion 41″, arranged at an obtuse angle to the pedal portion, such that the jack member can be positioned beneath the door during installation, with downward pressure on the pedal portion urging the door upwardly for convenient positioning and installation.

The upper and lower door brackets are operatively connected with the upper and lower mounting plates of the present system by upper and lower pairs of guide members, with each guide member of each pair being operatively movably engaged with a respective one of the first and second guide tracks of the upper and lower mounting plates. Thus, an upper pair of guide members includes guide members 42 and 44, which are respectively engaged and suspended from first and second guide tracks 20 and 22 of the upper mounting plate 12. Each of the guide members 42, 44 is suitably shaped to be moveably retained within and suspended from the respective guide track. Sliding movement of each of the first and second guide members 42 and 44 within respective ones of the first and second upper guide tracks 20, 22 acts to define the arcuate movement of the associated door D as it moves between its opened and closed positions, with guide member 42 moving generally rearwardly within its respective guide track 20, and guide member 44 moving generally laterally within its guide track 22. By this motion, the side edge of the door D, adjacent side frame SF, moves generally rearwardly into the enclosure within the door frame, thus limiting the extent to which the door D projects outwardly of the door opening into the associated room. Closing movement of the door can be limited by suitable stop member 45, mounted on the upper and side frames of the opening.

The lower pair of guide members, operatively connecting the lower door bracket with the lower mounting plate of the system, includes a first lower guide member 46 slidably movable within first lower guide track 24, and a second lower guide member 48, slidably movable within second lower guide track 26. Each of the first and second lower guides 46, 48 extend through the leg portions 38 of the lower door bracket 30, with the lower portion of the door thus generally supported on, and guided by, the guide members 46, 48, as they move within their respective tracks as the door moves between its closed and opened positions.

To facilitate insertion of the door D into the door frame, and removal therefrom, the present mounting system is preferably configured such that each of the lower guide members 46 and 48 is spring-biased downwardly from the lower door bracket 30, with the spring-biasing generally acting in opposition to the weight of the door. To this end, a pair of biasing springs 50 are respectively mounted in captive relationship on the first and second lower guide members 46, 48, with the biasing springs respectively positioned between lower end portions of the guide members, and the lower door bracket. By this arrangement, each of the guide members 46, 48 is upwardly movable, in opposition to the respective one of the biasing springs, to permit the guide members to be disengaged from the first and second guide tracks of the lower mounting plate.

To facilitate mounting, a pair of clip elements 51 are preferably provided which are respectively, removably positionable on the lower guide members 46, 48, between an upper end portion of each lower guide member and the lower door bracket 30. The clip elements 51 desirably act to maintain the lower guide members in a retracted orientation, so that the lower guide members are in disengaged relationship from the respective guide tracks 24, 26 of the lower mounting plate 14. After the door has been positioned as desired with respect to the upper mounting bracket, the clips 51 can be removed so that the guide members 46, 48 can be urged, under the action of the respective biasing springs 50, into engagement with respective guide tracks 24, 26.

As discussed above, the mounting arrangement of the present system mounts door D in a fashion such that the door moves through a generally arcuate path as it moves between its closed and opened positions. In order to selectively vary the extent to which the door projects into and through the door opening in the opened position thereof, the present mounting system includes an arrangement by which the upper and lower second guide members 44, 48 can be positioned in selectively spaced relationship from the side edge of the door, with such selective disposition of the guide members altering the arcuate path through which the door moves between its opened and closed positions.

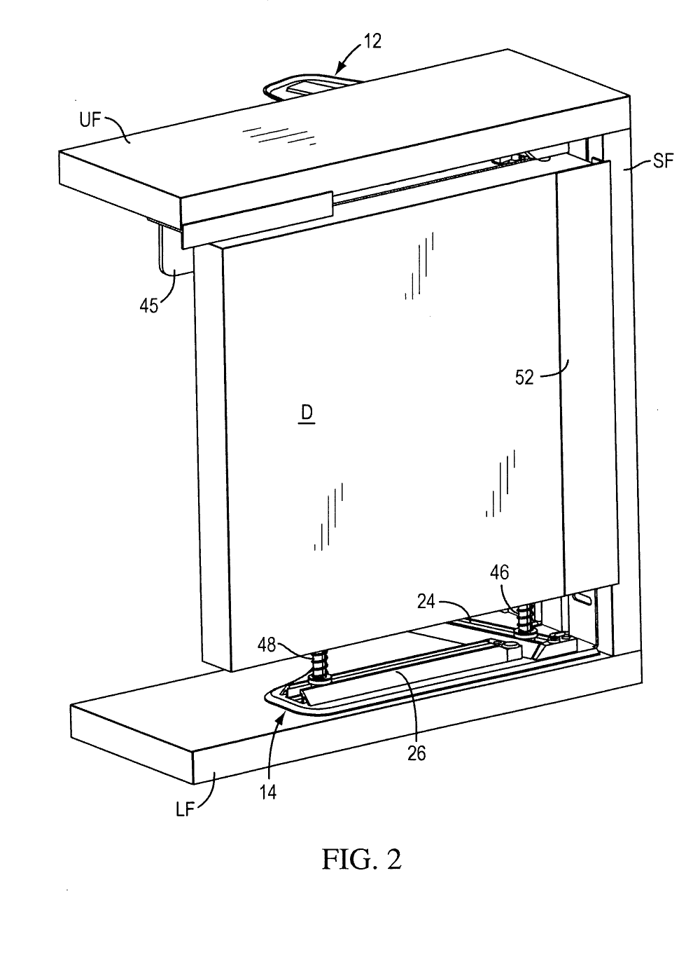

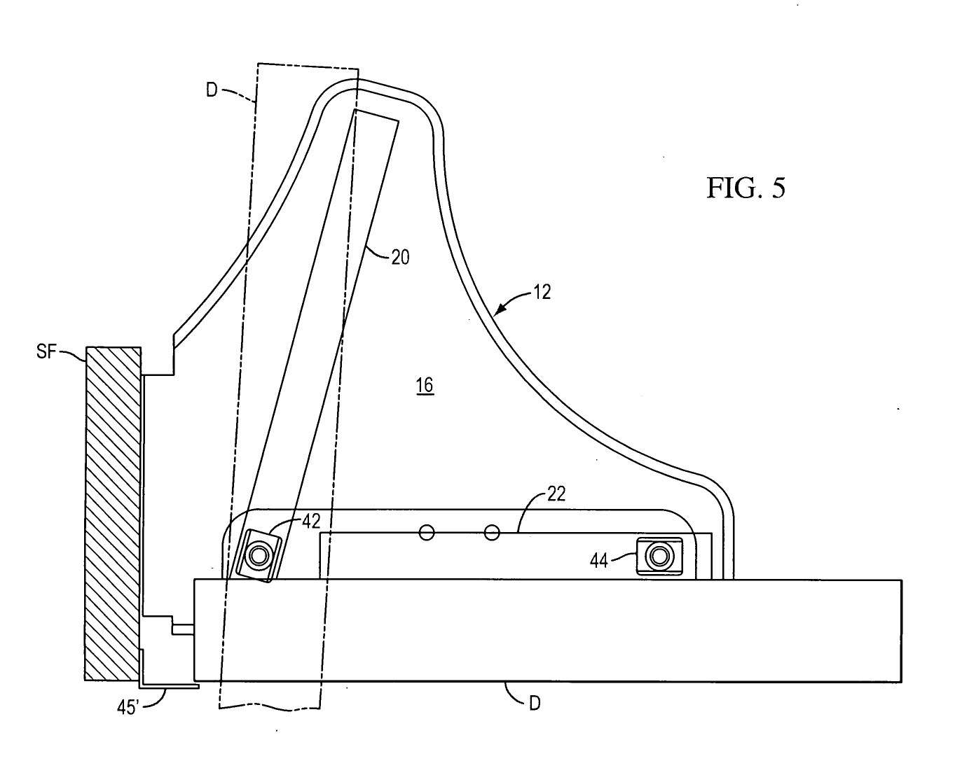

FIGS. 1, 2, and 5 illustrate the second guide members in a first selected disposition, wherein they are spaced a relatively greater distance from the side edge of the door, by disposition in selected ones of a plurality of openings respectively defined by the upper and lower door brackets 28, 30. In this disposition, the extent to which the door projects into the associated closet or other enclosure is maximized, for those applications where this is desired, thereby minimizing the extent to which the doors project into the associated room.

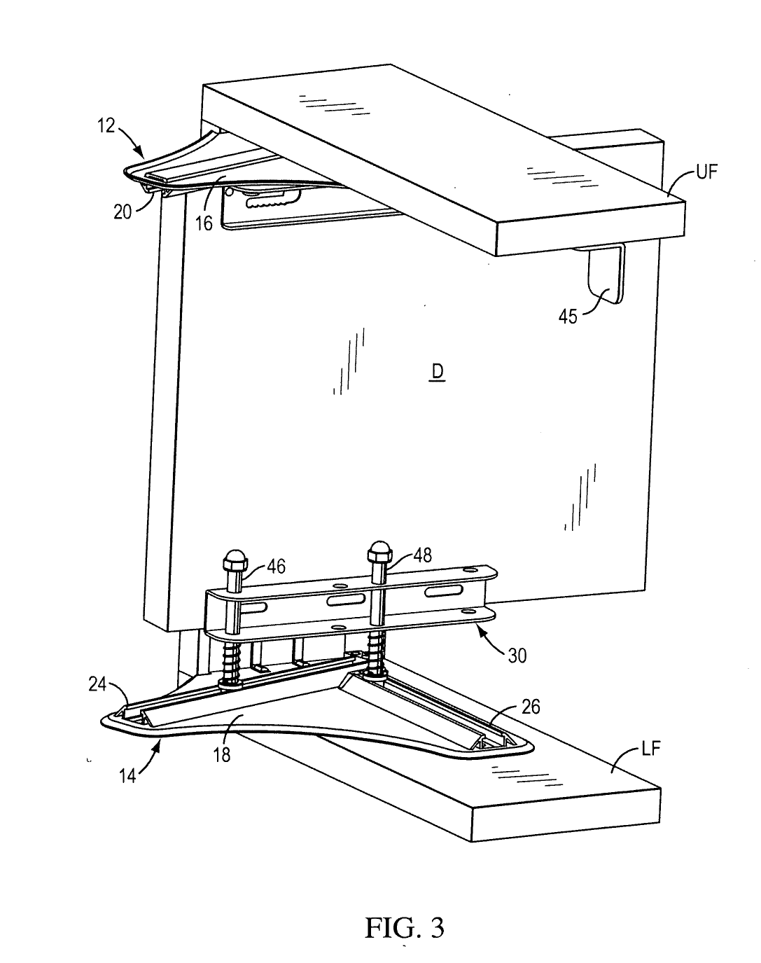

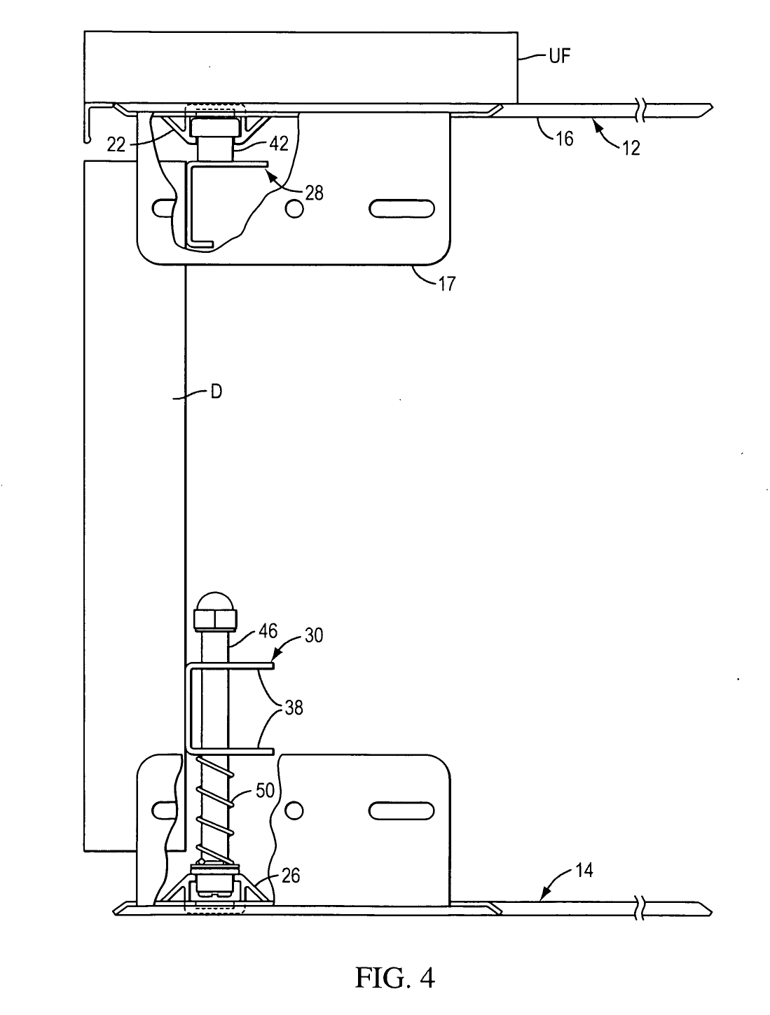

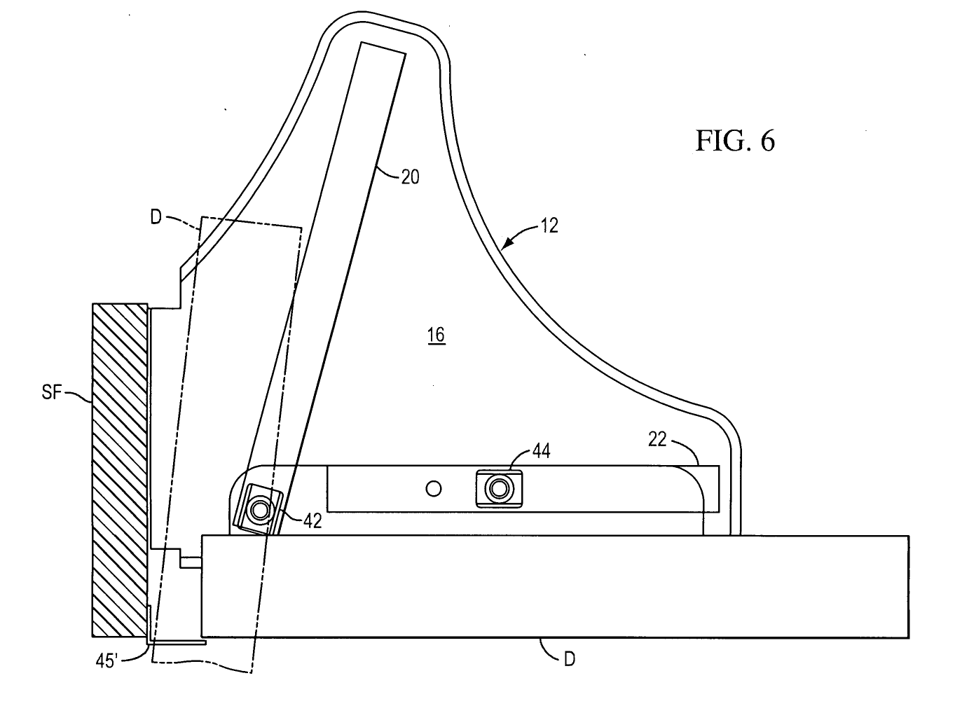

In contrast, FIGS. 3 and 6 illustrate the second door members 44, 48, in different, vertically aligned openings in the upper and lower brackets 28, 30, in which disposition the second guide members 44, 48 are in more closely spaced disposition to the side edge of the door. In this orientation, the degree to which the door projects into the associated closet, in its opened position, is minimized, and may be desirable for other applications. As will be appreciated, while the illustrated embodiment of the invention shows the second guide members in two different relative spacings with respect to the side edge of the door, it is within the purview of the present invention that a greater plurality of different spacings can be achieved, by providing a suitable number of openings in the upper and lower door brackets, thereby permitting further selective positioning of the guide members with respect to the side edge of the door.

Another aspect of the present door-mounting system facilitates installation of one or more doors into door openings of varying widths. By way of example, a typical five foot door opening would have a width of 58-59 inches for a by-pass door installation, 60 inches for a typical bi-fold installation. It is contemplated that the present door mounting system would facilitate use of one pair of doors to work for the entire 58-60 inch range.

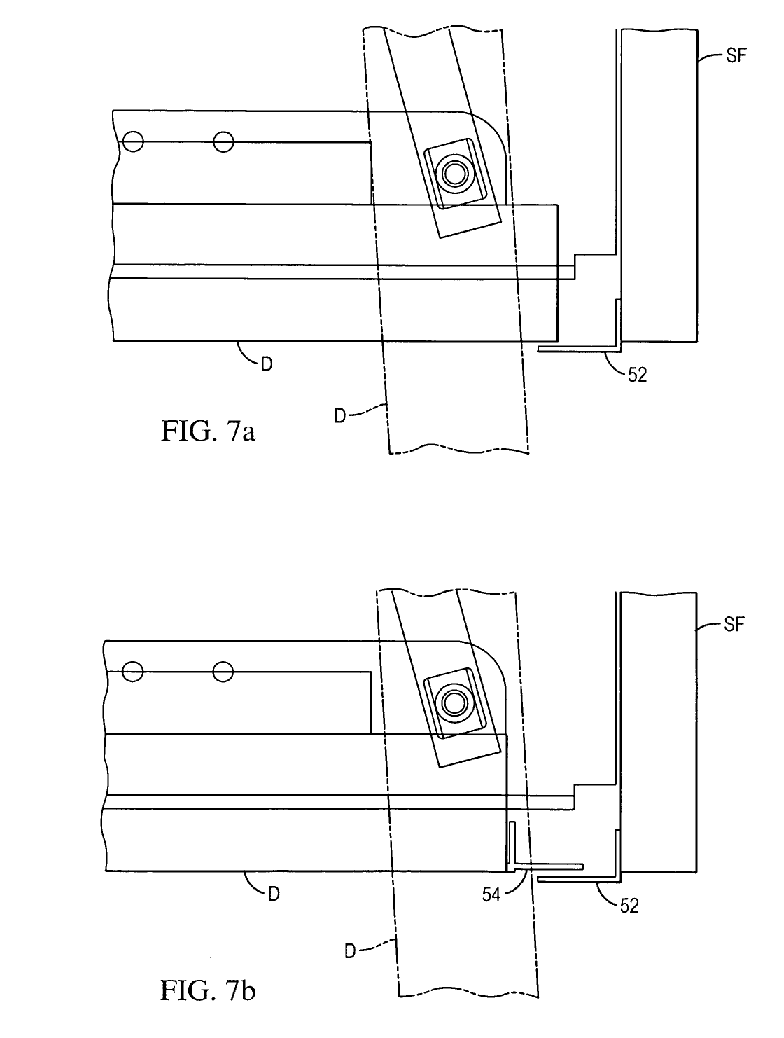

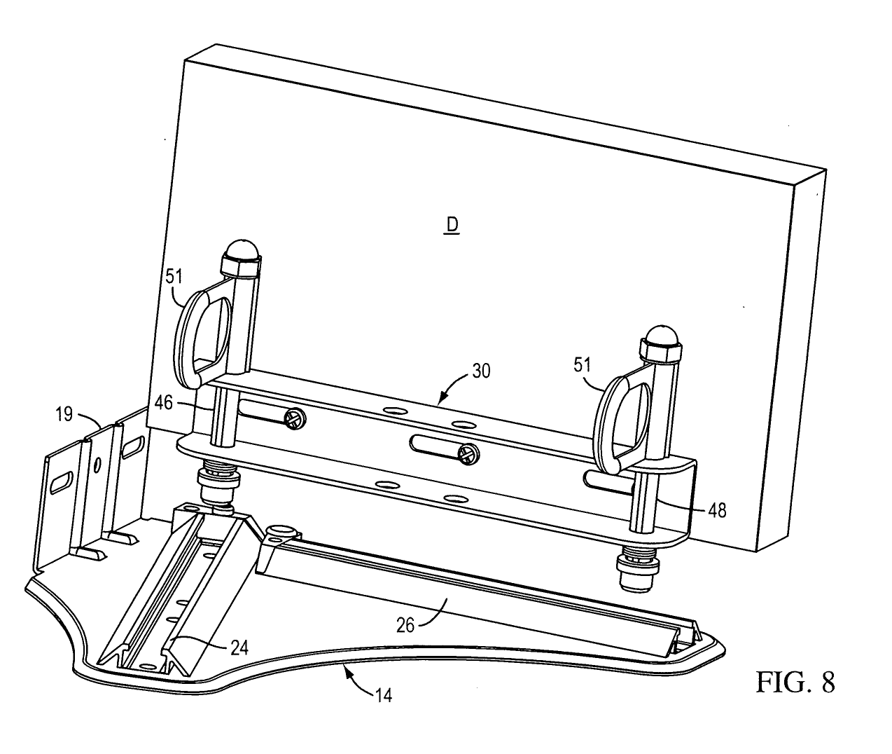

To this end, the present door mounting system includes at least one, and preferably first and second L-shaped trim members 52, 54 for covering the gap between the side edge of the door, and the side frame SF of the door opening. This arrangement is illustrated in FIGS. 7a and 7b. For some installations, use of a single one of the trim members, such as trim member 52, will be adequate to cover any gap between the side edge of the door and the side frame, while for other applications, each of the trim members 52, 54 can be provided, by respective positioning on the side frame and side edge of the door.

Each of the trim members has an outwardly facing surface for covering the gap between the side edge of the door and the side frame, with the outwardly facing surfaces of the trim members arranged in overlapping relationship, such as illustrated in FIG. 7, when it is desired to cover and finish a relatively larger gap. As will be appreciated, this aspect of the present invention promotes versatile and convenient use, providing an attractive and customized finished appearance for the door installation when completed.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

1. A door-mounting system for mounting a door in a door opening, comprising:
upper and lower mounting plates configured for respective mounting on upper and lower horizontal surfaces at the top and bottom of said opening, each of said mounting plates defining first and second guide tracks which respectively define track axes which intersect with each other,
upper and lower door brackets configured for respective mounting generally at the upper and lower edges of said door, generally adjacent a side edge of the door: and
upper and lower pairs of guide members, each guide member of each said pair being operatively movably engaged with a respective one of the first and second guide tracks of said upper and lower mounting plates, each said guide member of said upper and lower pairs being further engaged with the respective one of the upper and lower door brackets, so that movement of said guide members in said guide tracks permits said door to being moved inwardly and outwardly with respect to said opening between closed and opened positions,
each of said upper and lower door brackets defining a plurality of guide member openings for receiving the respective second guide member, of said upper and lower pairs of guide members, in selectively spaced relationship from said side edge of said door, whereby selective disposition of said second guide members in one of the plurality of guide member openings in the respective door bracket permits the door to be mounted to select the extent to which the door projects into the opening in the opened position thereof.

2. A door-mounting system in accordance with claim 1, wherein:
said upper door bracket defines a plurality of slots for receiving mechanical fasteners for securing the door to said upper door bracket, each of said slots defining an irregular surface at a lower edge thereof to facilitate installation of the mechanical fasteners and fitment of said door in the opening.

3. A door-mounting system in accordance with claim 1, wherein:
each of said upper and lower mounting plates includes a horizontal plate portion on which said first and second guide tracks of each said mounting plate is positioned, each said mounting plate further including a vertically oriented mounting flange, extending from the respective plate portion, to permit either one of said upper and lower mounting plates to be secured to a vertical surface defining said door opening.

4. A door-mounting system in accordance with claim 1, including:
a pair of biasing springs respectively mounted in captive relationship on each of said first and second guide members of said lower pair of guide members, said biasing springs being respectively positioned between lower end portions of said guide members and said lower door bracket, each of said first and second guide members of said lower pair of guide members being upwardly moveable, in opposition to the respective one of said biasing springs, to permit the first and second guide members to be disengaged from the first and second guide tracks of the lower mounting plate.

5. A door-mounting system in accordance with claim 4, wherein:
said lower door bracket has a generally U-shaped cross-section, including a web portion secured to said door, and a pair of leg portions through which said first and second guide members of said lower pair extend.

6. A door-mounting system in accordance with claim 1, wherein:
said upper door bracket includes a vertical leg portion defining a plurality of slots for receiving mechanical fasteners for securing the door to said upper door bracket, and a horizontal leg portion through which said first and second guide members of said upper pair of guide members extend.

7. A door-mounting system in accordance with claim 1, including:
a foot-operated jack member removably positionable beneath said door during mounting in said door-opening.

8. A door-mounting system in accordance with claim 4, including:
a pair of clip elements respectively, removably positionable on said lower guide members between an upper end portion of each said lower guide member and said lower door bracket, to maintain said lower guide members in disengaged relationship with said guide tracks of said lower mounting plate.

9. A door-mounting system in accordance with claim 1, including:
at least one trim member positionable at said side edge of said door, said trim member having an outwardly facing surface for covering a gap between said side edge of said door and a side frame of said door opening.

10. A door-mounting system in accordance with claim 9, including:
first and second trim members respectively positionable on said side edge of said door and said side frame of said door opening, with outwardly facing surfaces of said trim members being positioned in overlapping relationship.

11. A door-mounting system for mounting a door in a door opening, comprising:
upper and lower mounting plates configured for respective mounting on upper and lower horizontal surfaces at the top and bottom of said opening, each of said mounting plates defining first and second guide tracks which respectively define track axes which intersect with each other,
upper and lower door brackets configured for respective mounting generally at the upper and lower edges of said door, generally adjacent a side edge of the door:
upper and lower pairs of guide members, each guide member of each said pair being operatively movably engaged with a respective one of the first and second guide tracks of said upper and lower mounting plates, each said guide member of said upper and lower pairs being further engaged with the respective one of the upper and lower door brackets, so that movement of said guide members in said guide tracks permits said door to being moved inwardly and outwardly with respect to said opening between closed and opened positions; and
first and second trim members respectively optionally positionable on said side edge of said door and a side frame of said door opening, each said trim members having an outwardly facing surface, said outwardly facing surface being positionable in overlapping relationship to cover a gap between said side edge of said door and said side frame of said door opening.

12. A door mounting system in accordance with claim 11, wherein:
each of said upper and lower door brackets define a plurality of guide member openings for receiving the respective second guide member, of said upper and lower pairs of guide members, in selectively spaced relationship from said side edge of said door, whereby selective disposition of said second guide members in one of the plurality of guide member openings in the respective door bracket permits the door to be mounted to select the extent to which the door projects into the opening in the opened position thereof.

13. A door-mounting system in accordance with claim 11, wherein:
said upper door bracket defines a plurality of slots for receiving mechanical fasteners for securing the door to said upper door bracket, each of said slots defining an irregular surface at a lower edge thereof to facilitate installation of the mechanical fasteners and fitment of said door in the opening.

14. A door-mounting system in accordance with claim 11, including:
a pair of biasing springs respectively mounted in captive relationship on each of said first and second guide members of said lower pair of guide members, said biasing springs being respectively positioned between lower end portions of said guide members and said lower door bracket, each of said first and second guide members of said lower pair of guide members being upwardly moveable, in opposition to the respective one of said biasing springs, to permit the first and second guide members to be disengaged from the first and second guide tracks of the lower mounting plate.

15. A door-mounting system in accordance with claim 11, including:
a foot-operated jack member removably positionable beneath said door during mounting in said door-opening.

16. A door-mounting system in accordance with claim 14, including:
a pair of clip elements respectively, removably positionable on said lower guide members between an upper end portion of each said lower guide member and said lower door bracket, to maintain said lower guide members in disengaged relationship with said guide tracks of said lower mounting plate.
